(19) United States
(12) Patent Application Publication
(10) Pub. No.: US 2008/0288905 A1
(43) Pub. Date: Nov. 20, 2008

(54) Method and Apparatus for Congestion Based Physical Synthesis

(76) Inventors: Charles J. Alpert, Cedar Park, TX (US); Arvind K. Karandikar, Pune (IN); Zhuo Li, Austin, TX (US); Chin Ngai Sze, Austin, TX (US)

Correspondence Address: IBM CORP (YA);C/O YEE & ASSOCIATES PC, P.O. BOX 802333, DALLAS, TX, 75380, US

(21) Appl. No.: 11/748,514

(22) Filed: May 15, 2007

(51) Int. Cl. G06F 17/50

(52) U.S. Cl. 716/8

(57) ABSTRACT

A computer implemented method, apparatus, and computer usable program product for modifying a circuit design are provided in the illustrative embodiments. A set of candidate areas within the circuit design is identified for making a change to the circuit design. A cost associated with each candidate area in the set of candidate areas is determined to form a set of costs. The cost associated with a candidate area is the cost of making the change to the circuit design in the candidate area. Using the set of costs, a candidate area is selected from the set of candidate areas in which to make the change to the circuit design.

### BACKGROUND OF THE INVENTION

1. Field of the Invention

The present invention relates generally to an improved data processing system, and in particular, to a computer implemented method and apparatus for designing semiconductor circuits. Still more particularly, the present invention relates to a computer implemented method, apparatus, and computer usable program code for congestion based physical synthesis.

2. Description of the Related Art

Software is used for designing the electrical circuits, such as logic circuits. The circuits designed in this manner are fabricated into semiconductor chips commonly used in electronic devices such as computers, automobiles, and telecommunication equipment.

A variety of software tools is available for designing electrical circuits. The process of using software for designing a circuit is called physical synthesis. Physical synthesis is an incremental design process. In the incremental process, the design is completed and adjusted in increments or steps in order to achieve the desired characteristics in the circuit that is being designed.

Furthermore, physical synthesis is a sequential and iterative process. Physical synthesis is sequential because the steps of the process progress in a logical sequence where some aspects of the design have to be completed before others. The physical synthesis process is iterative because the steps may have to be repeated to obtain a satisfactory design result in that step. Design results are in part related to obtaining desired characteristics in the circuit that is being designed.

Some characteristics of circuits that are considered in physical synthesis are, for example, the timing, wire length, and delay in the designed circuit. Timing and delay are characteristics of a circuit that relate to the speed or performance of the circuit. For example, a circuit for a processor expected to operate at 2 GHz has specific timing requirements for the various components to finish their processing. Buffers are examples of circuits that can be added to the circuit being designed in order to manipulate the characteristics of the circuit.

### SUMMARY OF THE INVENTION

The illustrative embodiments provide a computer implemented method, apparatus, and computer usable program code for modifying a circuit design. A set of candidate areas within the circuit design is identified for making a change to the circuit design. A cost associated with each candidate area in the set of candidate areas is determined to form a set of costs. The cost associated with a candidate area is the cost of making the change to the circuit design in the candidate area. Using the set of costs, a candidate area is selected from the set of candidate areas in which to make the change to the circuit design.

### BRIEF DESCRIPTION OF THE DRAWINGS

The novel features believed characteristic of the invention are set forth in the appended claims. The invention itself; however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which illustrative embodiments may be implemented;

FIG. 2 depicts a block diagram of a data processing system in which illustrative embodiments may be implemented;

FIG. 3 depicts a block diagram of physical synthesis tool in accordance with an illustrative embodiment;

FIG. 4 depicts a block diagram of a physical synthesis process in accordance with an illustrative embodiment;

FIG. 5 depicts a block diagram of a bin in accordance with an illustrative embodiment;

FIG. 6 depicts a graph depicting a model for the cost of congestion in accordance with an illustrative embodiment;

FIG. 7 depicts a circuit design in accordance with an illustrative embodiment;

FIG. 8 depicts a tabulation of comparative data in accordance with an illustrative embodiment; and

FIG. 9 depicts a flowchart of the process of congestion based physical synthesis in accordance with an illustrative embodiment.

### DETAILED DESCRIPTION OF THE PREFERRED EMBODIMENT

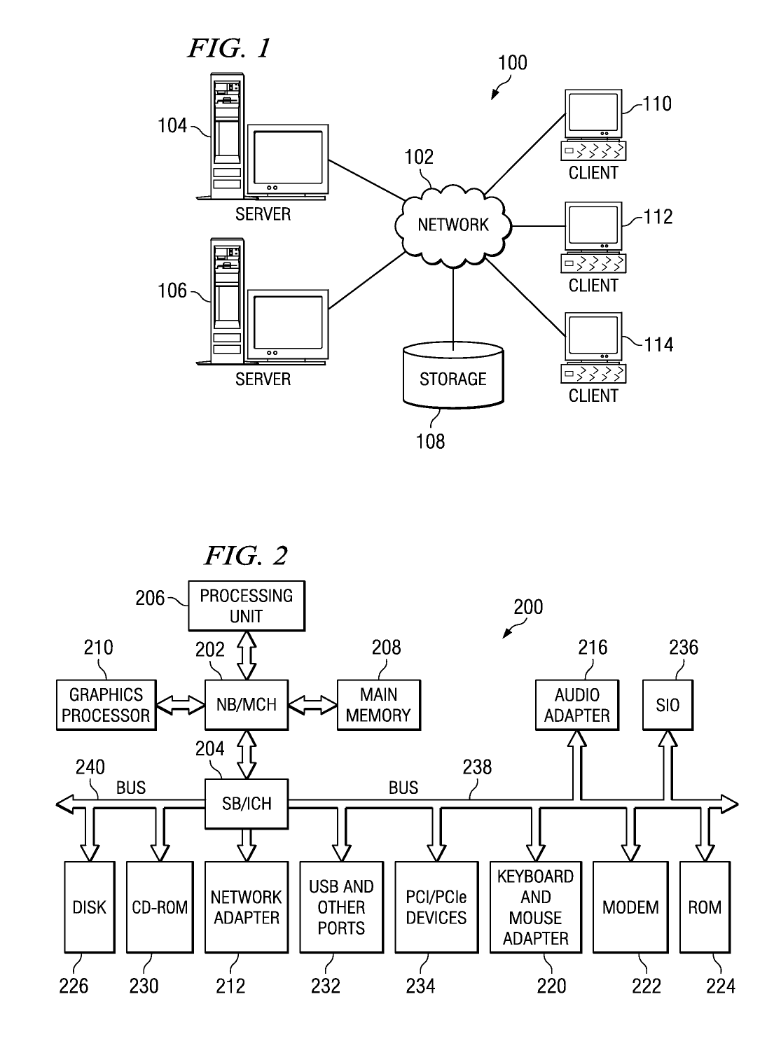

With reference now to the figures and in particular with reference to FIGS. 1 and 2, exemplary diagrams of data processing environments are provided in which illustrative embodiments may be implemented. It should be appreciated that FIGS. 1 and 2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, a client server environment such as depicted in FIG. 1 is also used for installing software applications for shared use. For example, a circuit design software is often installed in a client server environment such that several users working from several client computers can simultaneously access and work on a common circuit design.

With reference now to FIG. 2, a block diagram of a data processing system is shown in which illustrative embodiments may be implemented. Data processing system 200 is an example of a computer, such as server 104 or client 110 in FIG. 1, in which computer usable program code or instructions implementing the processes may be located for the illustrative embodiments.

In the depicted example, data processing system 200 employs a hub architecture including a north bridge and memory controller hub (NB/MCH) 202 and a south bridge and input/output (I/O) controller hub (SB/ICH) 204. Processing unit 206, main memory 208, and graphics processor 210 are coupled to north bridge and memory controller hub (NB/MCH) 202. Processing unit 206 may contain one or more processors and even may be implemented using one or more heterogeneous processor systems. Graphics processor 210 may be coupled to the NB/MCH through an accelerated graphics port (AGP), for example.

In the depicted example, local area network (LAN) adapter 212 is coupled to south bridge and I/O controller hub (SB/ICH) 204 and audio adapter 216, keyboard and mouse adapter 220, modem 222, read only memory (ROM) 224, universal serial bus (USB) and other ports 232, and PCI/PCIe devices 234 are coupled to south bridge and I/O controller hub 204 through bus 238, and hard disk drive (HDD) 226 and CD-ROM 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE) or serial advanced technology attachment (SATA) interface. A super I/O (SIO) device 236 may be coupled to south bridge and I/O controller hub 204.

An operating system runs on processing unit 206, coordinates, and provides control of various components within data processing system 200 in FIG. 2. The operating system may be a commercially available operating system such as Microsoft® Windows® XP (Microsoft and Windows are trademarks of Microsoft Corporation in the United States, other countries, or both). An object oriented programming system, such as the Java™ programming system, may run in conjunction with the operating system and provides calls to the operating system from Java™ programs or applications executing on data processing system 200. Java™ and all Java™-based trademarks are trademarks of Sun Microsystems, Inc. in the United States, other countries, or both.

Instructions for the operating system, the object-oriented programming system, and applications or programs are located on storage devices, such as hard disk drive 226, and may be loaded into main memory 208 for execution by processing unit 206. The processes of the illustrative embodiments may be performed by processing unit 206 using computer implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course, the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

Advanced technologies and large circuits can involve millions of circuit components. A circuit component, or simply “component”, is one or more electronic devices. A set of components is one or more components. An example of a component is a logic gate. A logic gate is a component that performs a specific logical computation.

Design of such circuits involves placing a large number of components onto an area of semiconductor material, such as silicon. To give an idea of the sizes involved, a component may only be 90 nanometers in size and the overall chip may not be any larger than a postage stamp accommodating millions of such components.

Physical synthesis software is used for designing a circuit that meets certain design parameters or specifications. For example, a circuit may be designed for a processor having specific operating frequency, such as 2 GHz. A specification, such as the operating frequency of the circuit, creates other specifications for the design of the circuit, such as timing of the circuit components, delay in propagating a signal between the circuit components, slew rate of the signal, power consumption, and many more.

A netlist is a listing of components and connections in a design. Physical synthesis software creates a placement of the contents of the netlist while attempting to satisfy all design specifications. This process of placement of the contents of a netlist is called physical synthesis. Physical synthesis results in a design of the circuit. A circuit design can be fabricated on the semiconductor material after physical synthesis.

Buffers are circuits that are placed within a circuit that is being designed in order to adjust the design parameters of the circuit. The process of placing a buffer within another circuit in this manner is called buffer insertion.

A circuit designed using physical synthesis is envisioned as the circuit will appear on the actual semiconductor chip when fabricated. The entire area of the semiconductor chip, such as a silicon chip, that is used for fabricating the circuit is divided into bins. A bin is an area within the overall chip. Numerous bins organized together form the entire chip. Bins are a design concept and do not physically exist on the silicon chip. Bins are generally used for facilitating the physical synthesis process and for analyzing the design that results from physical synthesis. At different stages of physical synthesis, the number of bins and their area may be different to match the characteristics of a design, such as the speed and quality of physical synthesis results, to the design parameters.

A bin is further subdivided into cells. A cell is an area within a bin where a part of the circuit or a set of components can be fabricated. Cells are classified as fixed or movable. A fixed cell is a cell whose position within the bin has to remain fixed within the bin. A movable cell is a cell that can be repositioned within the bin. Cells may be moved during physical synthesis for meeting design objectives such as design efficiencies, circuit specifications, ease of fabrication, and other similar considerations.

As described above, as the design of a circuit progresses, buffers may have to be inserted into the design to meet certain specifications for the circuit. Presently available technology for physical synthesis identifies candidate bins for buffers that have to be inserted in a design. Candidate bins are bins where a buffer can be inserted to solve a given problem, such as for adjusting the slew rate, timing, or power consumption of a section of the designed circuit.

Buffer insertion is used only as an example of design changes that can be made to a circuit design. Other changes can be made in a similar manner. Accordingly, a candidate bin is a bin that is a candidate for making the contemplated change in order to address an identified problem as described above.

Illustrative embodiments recognize that at any given step in the design, each bin on the chip has a pair of densities or density values. One density value in the pair represents the density of the fixed cells within the bin. This density value is referred to as the fixed density. Another density value in the pair represents the density of the movable cells within the bin. This density value is referred to as the movable density.

Illustrative embodiments further recognize that given the two density values, some areas of a given bin may be more congested than other areas. Congestion is the term used to indicate that an area has more items located within the area than a threshold number of items. Congestion value is an indication of congestion, and may be represented in numeric or any other implementation specific form. Congestion is relative, and an area of a bin is more congested than another area when the one or more density values for that area are higher than the same density values for the other area.

Illustrative embodiments further recognize that there is a cost associated with each candidate bin. For example, inserting a buffer in a candidate bin may require changes to the other components in that bin. How many other components have to be changed or moved as a result of the insertion can be one measure of the cost of inserting the buffer. Thus, inserting the buffer in one candidate bin may be more expensive than inserting the same buffer in another candidate bin.

Another measure of the cost can be how the wiring of the components within the bin is affected by the buffer insertion. Some wiring may become more complex after the buffer insertion as compared to before the buffer insertion. Thus, buffer insertion in one candidate bin may be more expensive wiring wise than buffer insertion in another candidate bin. Several other cost factors can be considered in selecting a candidate bin.

Illustrative embodiments recognize that congestion of a bin can itself be a cost consideration. Higher congestion is similar to higher cost. For example, inserting a buffer in a more congested bin presents less flexibility for the buffer insertion, as compared to inserting the buffer in a less congested bin.

Illustrative embodiments further recognize that present process for physical synthesis does not consider the congestion in a bin while identifying the candidate bins. A candidate bin may actually be a poor candidate bin if the congestion within that bin is high as compared to the other candidate bins. Furthermore, a bin that is not identified as a candidate bin may actually be a good candidate bin when congestion of the various bins is considered.

Illustrative embodiments further recognize that even when a candidate bin is selected by the present process for physical synthesis, that selection and other decisions in a particular step of physical synthesis are not communicated to subsequent steps. Lack of communication between the various steps of physical synthesis often requires re-doing some of the work done in a previous step. For example, inserting a second buffer in a later step may disturb the placement of a buffer inserted in a previous step, making it necessary to rework the buffer insertion from the previous step.

Therefore, the illustrative embodiments provide a computer implemented method, apparatus, and computer usable program code for physical synthesis process that takes into consideration the congestion of the bins during design, and provides communication between the various design steps will be advantageous. Some exemplary advantages of such illustrative embodiments are saved time and effort in subsequent steps of the design; reduced errors by avoiding rework of previous steps; lower cost of buffer insertion; and better candidate bin selection.

The advantages listed above are only exemplary and not intended to be limiting on the illustrative embodiments. Additional advantages may be realized by specific illustrative embodiments, and implementations of specific illustrative embodiments. Furthermore, a particular illustrative embodiment may have some, all, or none of the advantages enumerated above.

Additionally, buffer insertion is only an exemplary process in physical synthesis, used for the clarity of the description of the illustrative embodiments. Other processes and steps can affect congestion, and can benefit from considering congestion during physical synthesis. For example, re-powering of gates affects congestion. Re-powering of gates is in essence changing the size of a logic gate. A larger gate can drive a longer interconnect wire, and can also speed up the computation. A larger gate also generally increases congestion.

As another example, cloning affects congestion. Cloning is the duplication of a logic circuit to improve the wiring within the circuit. Cloning improves the wiring, but can also increase the congestion.

As another example, moving or breaking apart a logic gate can affect congestion. Logic gates may be moved or broken apart into smaller gates for performing the same logical computation but with improved wiring, timing, delay and other circuit characteristics. Moving the logic gate alters the congestion of the previous and new locations of the logic gate. If more components result from breaking up the logic gate, the congestion may increase.

The illustrative embodiments described below provide a model for using congestion information in the physical synthesis steps. The illustrative embodiments also provide a model for communicating congestion and other design considerations between the various steps of physical synthesis.

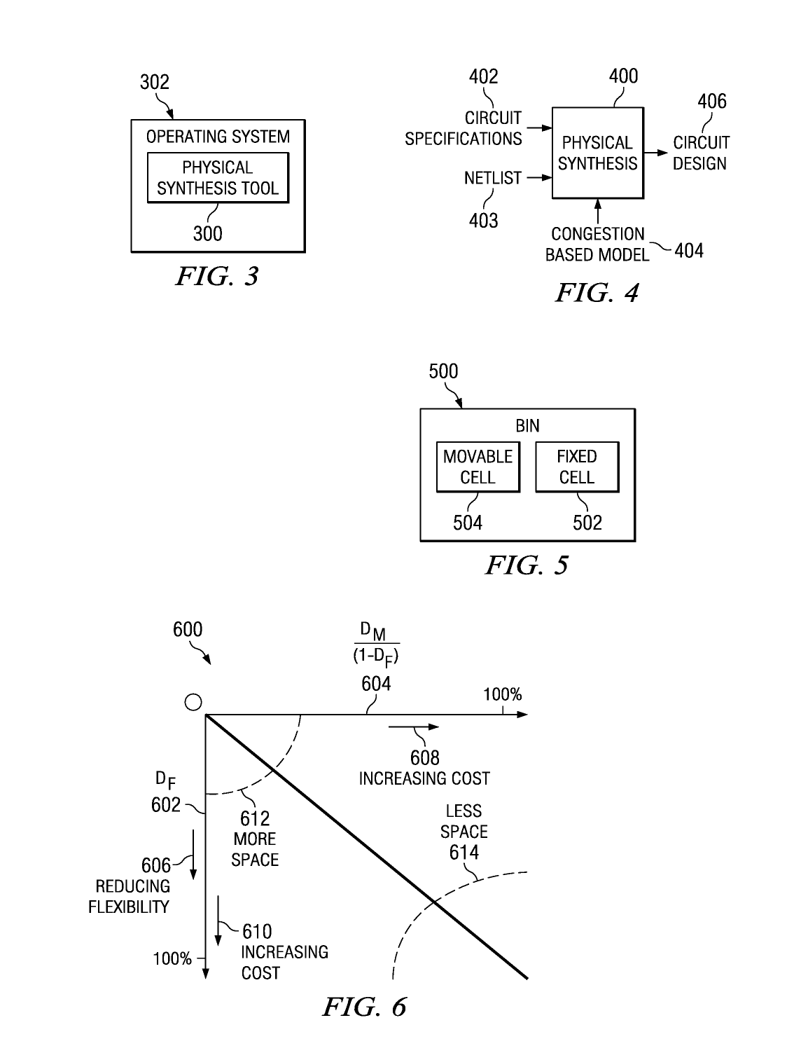

With reference now to FIG. 3, a block diagram of physical synthesis tool is depicted in accordance with an illustrative embodiment. Physical synthesis tool 300 is depicted as a software application running under operating system 302 on a data processing system, such as client 114 or server 104 in FIG. 1. Often, a physical synthesis tool is run in a client server environment where several users can access using a client computer, such as client 114 in FIG. 1, an installation of the physical synthesis tool, or parts thereof, installed on a server computer, such as server 101 in FIG. 1.

Physical synthesis tool 300 includes database 304, which is used for storing and manipulating design components, design artifacts, design templates, design parameters, and other pieces of information used in designing a circuit using the physical synthesis tool. Database 304 may be a relational database, an object oriented database, flat file, index file or any other data structure suitable for storing similar information in this manner.

Physical synthesis tool 300 further includes user interface component 306, which provides a user the capability for manipulating a circuit design. In a client server environment, different parts of a physical synthesis tool can be installed on different server and client computers. For example, database 304 can be installed on a server, and user interface 306 installed on one or more client computers. Examples of physical synthesis tools are Physical Design Synthesis™ software manufactured by International Business Machines Corporation®, and BlastFusion™ software manufactured by Magma Design® Corporation.

With reference now to FIG. 4, a block diagram of a physical synthesis process is depicted in accordance with an illustrative embodiment. Physical synthesis process 400 can be implemented in physical synthesis tool 300 in FIG. 3.

Physical synthesis process 400 accepts circuit specifications 402 as input. Physical synthesis process 400 accepts netlist 403 as another input. Physical synthesis process 400 is modified in accordance with the illustrative embodiment, and further accepts congestion based model 404 as an additional input. Physical synthesis process 400 creates circuit design 406 as output. Circuit design that results from a physical synthesis process in this manner is called a “placed circuit design”.

With reference now to FIG. 5, a block diagram of a bin is depicted in accordance with an illustrative embodiment. Bin 500 can be a bin in circuit design 406 in FIG. 4.

Bin 500 contains several cells. Cells in bin 500 can be a mix of fixed cells and movable cells as described above. Fixed cell 502 is an exemplary fixed cell in bin 500. Movable cell 504 is an exemplary movable cell in bin 500.

With reference now to FIG. 6, a graph depicting a model for the cost of congestion is depicted in accordance with an illustrative embodiment. Graph 600 is based on a congestion cost model that can be implemented as congestion based model 404 to physical synthesis process 400 in FIG. 4.

Graph 600 shows density of fixed cells, that is, fixed density 602 along the Y-axis. Graph 600 shows congestion model 604 along the X-axis. Congestion model 604 is represented by the formula D_{M}/(1−D_{F}). D_{M} represents movable density, and D_{F} represents fixed density as described above.

As shown in graph 600, the flexibility to make any changes to the contents of a bin, such as buffer insertion, decreases with increasing fixed density. This reduction in flexibility is depicted by arrow 606. Flexibility reduces for steps like buffer insertion because with increasing fixed density, more and more of the bin space is occupied by fixed cells which cannot be moved, and less and less space is available to accommodate the changes.

Similarly, as the movable density increases, congestion due to movable cells increases, and the value of the congestion model increases. Even though the cells are movable, the larger the number of movable cells gets in a bin, the smaller the movability gets for those movable cells. As a result, the value of the congestion model increases with increasing movable density. Value of the congestion model is one example of congestion value.

As arrows 608 and 610 show, increasing movable density or increasing fixed density both result in an increased cost for making any changes, such as buffer insertion. The increased cost in this example is the increased cost of congestion. Thus, when both the densities are low in a bin, there is more space available for making any changes to the contents of the bin. Accordingly, region 612 of the graph depicts the availability of more space. Conversely, when both the densities are high in a bin, there is less space available for making any changes to the contents of the bin. Accordingly, region 614 of the graph depicts the availability of less space.

In this manner, the cost of congestion for several candidate bins can be determined according to the congestion model shown in graph 600. Presently used buffer insertion techniques only select the candidate bins based on timing and power information. One example of a presently used buffer insertion technique is the Van Ginneken's algorithm. With congestion cost model, buffer insertion can additionally balance the congestion with other design parameters for a more efficient and effective buffer placement as compared to the presently used techniques.

The costs of congestion for the several candidate bins can be used in the manner described above to determine whether one candidate bin is better suited for the proposed changes than another candidate bin. In this way, cost of congestion can be used to bias the selection of a candidate bin for steps such as buffer insertion.

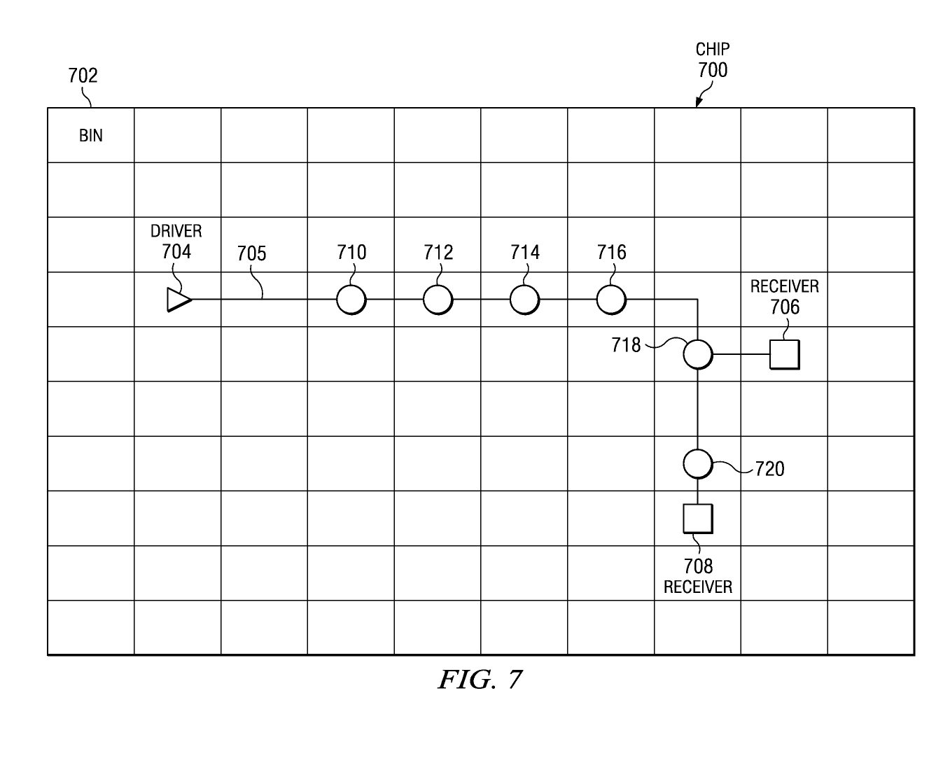

With reference now to FIG. 7, a circuit design is depicted in accordance with an illustrative embodiment. The circuit design may be 406 in FIG. 4. The design of the circuit may be performed using a physical synthesis tool, such as physical synthesis tool 300 in FIG. 3. The components of the circuit design may be stored in a database, such as database 304 in FIG. 3.

Chip 700 is a semiconductor chip, which is depicted as divided into several bins, such as bin 702. Each square similar to bin 702 represented within chip 700 is a bin. Driver 704 is a circuit component, which is shown connected via wire 705 to receiver 706 and receiver 708. Receivers 706 and 708 are also circuit components. Bins 710, 712, 714, 716, and 718 are candidate bins for a buffer insertion. Buffer insertion is used as an example of a change that is needed to make the circuit on chip 700 conforms to some exemplary circuit specification.

Candidate bins 710-718 may be identified using a physical synthesis process such as physical synthesis process 400 in FIG. 4. In accordance with the illustrative embodiment, however, now a cost of congestion can be associated with each candidate bin 710-718 in the manner described with respect to FIG. 6. For example, assume that a buffer inserted in any one of candidate bins 710-718 will achieve the purpose behind the buffer insertion. Based on the congestion model described in FIG. 6, inserting a buffer in candidate bins 710, 714, and 718 in a particular design may incur higher congestion costs than inserting the buffer in candidate bins 712 and 716.

Thus, with the congestion model of the illustrative embodiments, candidate bins with the lowest cost of buffer insertion can be identified. Furthermore, in a particular design scenario, a bin 720 may be additionally identified as a candidate bin based on bin 720's low cost of congestion and the acceptable quality of design after inserting buffer in bin 720, that would have not been otherwise identified as a candidate bin without the benefit of the congestion model of the illustrative embodiments.

For example, in a specific design project performed using IBM's existing Physical Design Synthesis (PDS) software, a circuit designer can specify that the software should select as candidate bins for a buffer insertion only those bins that have some available space, such as a bin that is at most 90 percent full. As a result of such a specification, a smaller number of candidate bins is likely to be returned by the existing software. A bin that is not identified as a candidate bin may in fact be the best candidate for the buffer insertion if the congestion model of illustrative embodiments is considered during the selection.

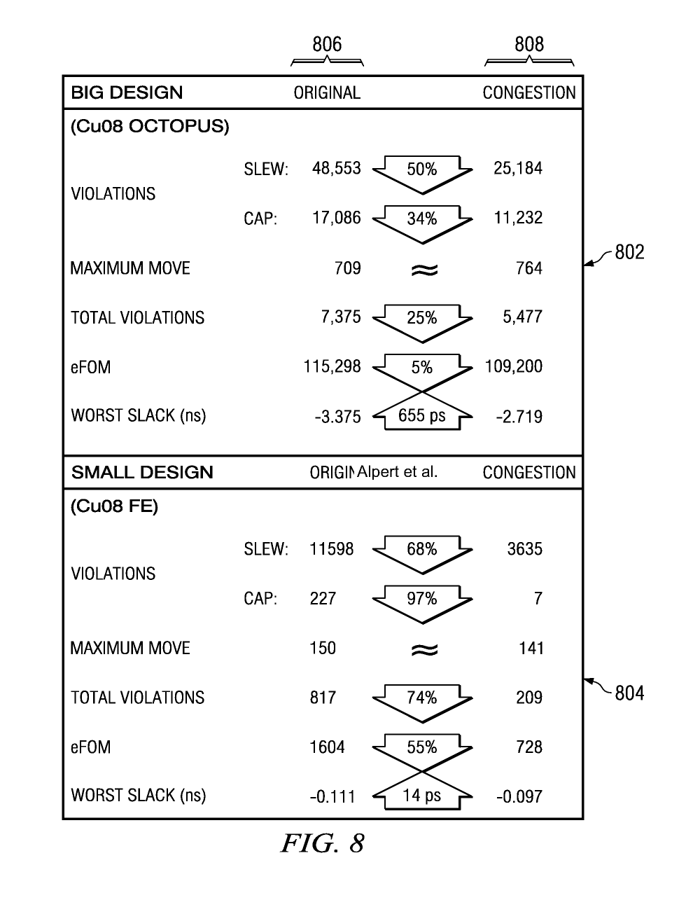

With reference now to FIG. 8, a tabulation of comparative data is depicted in accordance with an illustrative embodiment. The design of the circuit may be performed using a physical synthesis tool, such as physical synthesis tool 300 in FIG. 3. The data pertaining to the analysis of the design may be stored in a database, such as database 304 in FIG. 3.

In a specific implementation, the congestion model of the illustrative embodiments described above was applied to the IBM's Physical Design Synthesis software. The modified software was then used to design two exemplary semiconductor chips.

The first exemplary design involved components of a minimum size of 90 nanometers, forming approximately two million nine hundred thousand gates, and approximately three million connections. This design is an example of what is considered a big design in the semiconductor industry.

The second exemplary design involved components of a minimum size of 90 nanometers, forming approximately three hundred fourteen thousand gates, and approximately three hundred thirty eight thousand connections. This design is an example of what is considered a small design in the semiconductor industry.

FIG. 8 shows tabulation 800 of comparative data for each design. The design characteristics of the big design are shown in rows 802, and those of the small design are shown in rows 804.

Column 806 contains the design characteristics of the design generated by the Physical Design Synthesis software in the existing form. Column 808 contains the design characteristics of the design generated by the Physical Design Synthesis software using the congestion model as described with respect to graph 600 in FIG. 6. Table 800 compares the data under columns 806 and 808.

As can be seen, for each design, the total number of slew and capacitance violations is reduced by using the congestion model of the illustrative embodiments. Slew and capacitance violations are two types of variations in the design of the circuit from the specification of the circuit.

When a component is added to a bin, the component may have to be moved until a final step fixing the component's place in the bin is taken. This step of fixing the location of the component is called legalization. Maximum moves of the components for legalization with the congestion model of the illustrative embodiments remained comparable to the maximum moves of the components without the congestion model of the illustrative embodiments. Additionally, the total number of violations is reduced by using the congestion model of the illustrative embodiments.

In these examples, eFOM is a figure of merit that represents the quality of the design. The lower the eFOM number the better the design. eFOM number is reduced upon using the congestion model in accordance with the illustrative embodiments.

Worst slack is a difference between the target timing of the chip and the real delay in the chip. Ideally, this number should be zero, but the smaller the number the better the design. Worse slack was reduced by using the congestion model in accordance with the illustrative embodiments.

Each of these design characteristics are specific to the software used for this specific implementation of the illustrative embodiments. Other design characteristics can be similarly compared in other implementations. Furthermore, the numeric data before and after including the congestion model in the Physical Design Synthesis software are only exemplary based on the specific design projects undertaken, and are not intended to be limiting on the illustrative embodiments.

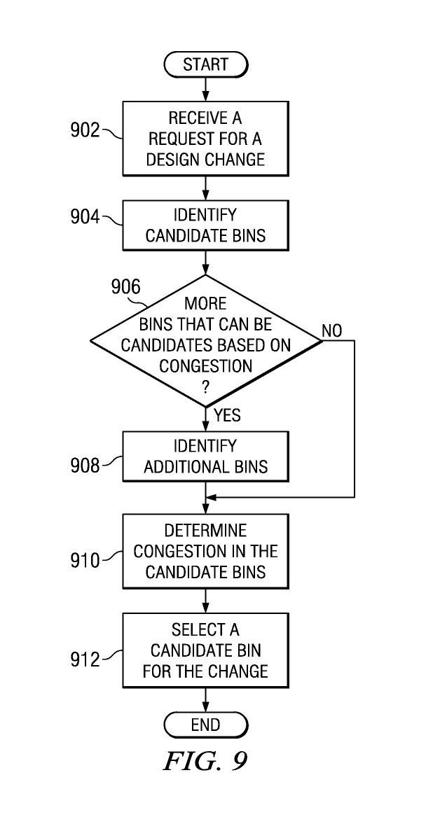

With reference now to FIG. 9, a flowchart of the process of congestion, based physical synthesis is depicted in accordance with an illustrative embodiment. The process can be implemented in physical synthesis process 400 in FIG. 4.

The process begins by receiving a request for a change in a circuit being designed (step 902). The process identifies a set of candidate bins where the change may be made (step 904). A set of candidate bins is one or more candidate bins. Step 904 can be implemented for selecting the candidate bins according to the existing physical synthesis process.

Next, the process determines if more candidate bins can be identified based on congestion in those bins (step 906). If the process determines that more bins can be identified (“yes” path of step 906), the process identifies additional candidate bins (step 908). The additionally identified bins are added to the set of candidate bins. The process then proceeds to the next step. If, however, the process determines that additional bins cannot be identified (“no” path of step 906), the process proceeds to the next step.

As the next step, the process determines the congestion values for the set of congestion bins (step 910). Based on the congestion values, the process selects a candidate bin for implementing the requested change (Step 912). The process ends thereafter.

Thus, in the illustrative embodiments described above, a computer implemented method, apparatus, and computer program product are provided for making a modification to a circuit design. When a change in a design of a circuit is contemplated, a number of possible candidate areas on the design are identified for making the change. Each possible candidate area has a cost associated with making the design modification in that candidate area. This cost includes a congestion value as described above. Based on the cost of making the design modification in each possible candidate area, a candidate area is selected. The selected candidate area of the design is then used for making the contemplated design modification.

Thus, including the congestion model of the illustrative embodiments in the various steps of the physical synthesis process produces an overall better design of the circuit. Reworking of the changes from previous steps is reduced or eliminated, and additional candidate bins can be identified. Furthermore, the candidate bins identified using the congestion model of the illustrative embodiment may be better candidates in some instances.

The design resulting from the physical synthesis software using the illustrative embodiments has better design characteristics than designs resulting from the physical synthesis software without using the illustrative embodiments. The better design has been shown to have better performance and is truer to the circuit specification.

Because the changes are made without repetitive rework, illustrative embodiments allow designs to be completed sooner allowing for faster time to market. Faster time to market is an important commercial consideration in the semiconductor industry.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer-readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

Further, a computer storage medium may contain or store a computer-readable program code such that when the computer-readable program code is executed on a computer, the execution of this computer-readable program code causes the computer to transmit another computer-readable program code over a communications link. This communications link may use a medium that is, for example without limitation, physical or wireless.

A data processing system suitable for storing and/or executing program code will include at least one processor coupled directly or indirectly to memory elements through a system bus. The memory elements can include local memory employed during actual execution of the program code, bulk storage, and cache memories, which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for modifying a circuit design, the computer implemented method comprising:
Identifying in a computer, a set of candidate areas within the circuit design for making a change to the circuit design;
determining in the computer, a cost associated with each candidate area in the set of candidate areas to form a set of costs, wherein the cost associated with a candidate area is a cost of making the change to the circuit design in the candidate area;
selecting in the computer, a candidate area from the set of candidate areas in which to make the change to the circuit design, using the set of costs; and
generating a response by the computer based on the selecting.

2. The computer implemented method of claim 1, wherein the change to the circuit design is a component insertion.

3. The computer implemented method of claim 2, wherein the component insertion is a buffer insertion and each candidate area in the set of candidate areas is a candidate buffer insertion position.

4. The computer implemented method of claim 1, wherein the cost associated with a candidate area in the set of candidate areas comprises:
a congestion value associated with the candidate area.

5. The computer implemented method of claim 4, wherein the congestion value is a function of a fixed density of the candidate area and a movable density of the candidate area.

6. The computer implemented method of claim 4, wherein the congestion value associated with the candidate area is an input to a physical synthesis process for circuit design.

7. A computer usable program product comprising a computer usable medium including computer usable code for modifying a circuit design, the computer usable code comprising:
computer usable code for identifying a set of candidate areas within the circuit design for making a change to the circuit design;
computer usable code for determining a cost associated with each candidate area in the set of candidate areas to form a set of costs, wherein the cost associated with a candidate area is a cost of making the change to the circuit design in the candidate area;
computer usable code for selecting a candidate area from the set of candidate areas in which to make the change to the circuit design, using the set of costs; and
computer usable code for generating a response by the computer based on the selecting.

8. The computer usable program product of claim 7, wherein the change to the circuit design is a component insertion.

9. The computer usable program product of claim 8, wherein the component insertion is a buffer insertion and each candidate area in the set of candidate areas is a candidate buffer insertion position.

10. The computer usable program product of claim 7, wherein the cost associated with a candidate area in the set of candidate areas comprises:
a congestion value associated with the candidate area.

11. The computer usable program product of claim 10, wherein the congestion value is a function of a fixed density of the candidate area and a movable density of the candidate area.

12. The computer usable program product of claim 10, wherein the congestion value associated with the candidate area is an input to a physical synthesis process for circuit design.

13. A data processing system for modifying a circuit design, the data processing system comprising:
a storage device, wherein the storage device stores computer usable program code; and
a processor, wherein the processor executes the computer usable program code, and wherein the computer usable program code comprises:
computer usable code for identifying a set of candidate areas within the circuit design for making a change to the circuit design;
computer usable code for determining a cost associated with each candidate area in the set of candidate areas to form a set of costs, wherein the cost associated with a candidate area is a cost of making the change to the circuit design in the candidate area;
computer usable code for selecting a candidate area from the set of candidate areas in which to make the change to the circuit design, using the set of costs; and
computer usable code for generating a response by the computer based on the selecting.

14. The data processing system of claim 13, wherein the change to the circuit design is a component insertion.

15. The data processing system of claim 14, wherein the component insertion is a buffer insertion and each candidate area in the set of candidate areas is a candidate buffer insertion position.

16. The data processing system of claim 13, wherein the cost associated with a candidate area in the set of candidate areas comprises:
a congestion value associated with the candidate area.

17. The data processing system of claim 16, wherein the congestion value is a function of a fixed density of the candidate area and a movable density of the candidate area.

18. The data processing system of claim 12, wherein the congestion value associated with the candidate area is an input to a physical synthesis process for circuit design.
